(19) United States
(12) Patent Application Publication
(10) Pub. No.: US 2006/0283955 A1
(43) Pub. Date: Dec. 21, 2006

(54) Card reading device

(75) Inventors: Thomas Riester, Villingen-Schwenningen (DE); Torsten Wahler, Bad Duerrheim (DE)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 10/555,036

(22) PCT Filed: Mar. 24, 2004
(86) PCT No.: PCT/EP04/03121

§ 371 Date: Oct. 27, 2005

(30) Foreign Application Priority Data
May 12, 2003 (DE) 103 21 231.0

(51) Int. Cl. G06K 13/00; G06K 13/04

(52) U.S. Cl. 235/475; 235/479

(57) ABSTRACT

The invention relates to a card reading device (1) having an automatic feed-in device that transports the card (3) to a reading position, contacts (8) grouped in a rigid set of contacts (7), which touch the card (3) during reading. In known embodiments of said devices, the flat construction thereof does not enable reliable contacting. The invention offers a solution for said problem by providing an automatic feed-in device having at least one driver (9), wherein the card reading device (1) has a guide comprising at least one first guide element (11) and a corresponding second guide element (12), the first guide element (11) being rigidly connected to the set of contacts (7) and the second guide element (12) being permanently connected to the driver (9). The second guide element (12) interacts with the first guide element (11) in such a way that the driver (9) is moved towards the contacts (8) when a movement in feed-in direction or opposite the feed-in direction in the direction of separation occurs.

The invention relates to a card reading device, in particular for a tachograph, having an insert for the insertion of a card, having an automatic feed-in device, which transports the card in the insertion direction into the card reading device and transports it into a read position, having a plurality of contacts, which are combined in at least one contact array, arranged in the card reading device such that it cannot move, and which come into contact, at least temporarily, with the card in the read position.

Modern tachographs use a chipcard instead of the previously used tachograph chart for the purpose of registering the driving times and interval times and the vehicle-specific data, in which case all of the information is stored on the chipcard in such a manner that at least some of it can be amended. These tachographs are therefore also known as digital tachographs. Relevant standards prescribe the format for the used cards and the operation of the reading or writing devices as regards various aspects. These provisions are used primarily to protect against fraudulent manipulations and to ensure the operation and compatibility of the used reading and writing devices and cards. The provisions need to be adhered to particularly stringently owing to the legally relevant proof nature of the data stored on the card. Examples of design provisions which are relevant to the invention for the card reading device are the closure of the device during the transmission of information between the card and the apparatus for preventing manipulations and the electrical contact-making as regards the cards used. In addition to the legal provisions, such a device also needs to meet numerous other design requirements, however. For installation in a vehicle cockpit, an extremely flat design of the card reading device is desired for space reasons. Furthermore, the operation of the apparatus needs to be resistant to vibrations and far-reaching temperature changes. In addition, the apparatus should be insensitive to contamination, in particular contamination owing to aggressive media, for example diesel fuel.

An apparatus of the abovementioned type, which largely satisfies the legal and design provisions, is already known from the German patent application DE 197 32 583. This specification proposes feeding a data card automatically into the card reading device with lateral guidance by means of motor-driven transport rollers, contact-pressure elements acting as opposing bearings for the transport rollers, and a resiliently mounted closure element closing the apparatus during the reading and writing operations.

The flat design urgently required for these devices means that the contacts combined to form a contact array need to be arranged rigidly in the device and cannot be designed as components to be lowered onto the card in a controlled manner. The possibility of moving the contact array in the distancing direction in relation to the card would represent an obstacle to the flat design and would also entail unacceptably high production costs owing to the flexible conductor connection required between the contact array and the printed circuit board alone. The known embodiment shows that the required precision for positioning the contacts of the contact array can barely be realized owing to the tolerances of the components involved, and difficulties would result when making contact between the card reading device and the card which would absolutely need to be avoided. The short spring path of the contacts in the contact array is in an unfavorable case insufficient to compensate for the inaccuracies in the thickness of the card and the bend in the printed circuit board and the other components.

On the basis of the problems of the prior art, it is the object of the invention to provide a card reading device which meets the valid legal provisions explained above, meets the design boundary conditions, provides the convenience of an automatic card feed-in device and always ensures that reliable contact is made between the contact array of the card reading device and the card.

In order to achieve the object, the invention proposes a card reading device of the type mentioned initially, in which the automatic feed-in device has at least one driver, the card reading device has a guide having at least one first guide element and a corresponding second guide element, the first guide element being rigidly connected to the contact array, and the second guide element being fixedly connected to the driver, and the second guide element interacting with the first guide element such that the driver is guided in the distancing direction in relation to the contacts in the event of a movement in and/or against the insertion direction.

A decisive advantage of the invention lies in the reliable compensation of height tolerances of the card and in reliable contact thus always being made between the card reading device and the card, with a flat design being made possible at the same time. In this manner, a card reading device of the generic type becomes suitable for the specific use only since the entire range of the tolerances occurring during manufacture can be compensated for by the principle according to the invention. The irresistible simplicity of the proposed solution dispenses with complex mechanisms and additional drives for lifting or lowering the contacts onto the card.

In addition to the novel card reading device, the invention also proposes a method for transporting a card in a card reading device, in which the card slides in a driver when it is inserted through an insertion opening into the card reading device, a drive moves the driver in the card reading device in the insertion direction, the driver clamps the card, at least temporarily, in the event of a movement in the insertion direction, by means of an upper clamping part, which bears on a first flat side of the card during clamping, and a lower clamping part, which bears on the second flat side of the card during clamping, a guide having a first guide element, which is rigidly connected to the contact array, whilst interacting with a second guide element on the driver, which corresponds to the first guide element, guides the driver in the distancing direction in relation to the contacts of the contact array in the event of a movement in the insertion direction, contact is made with the card by contacts of a contact array.

In addition to the advantages already offered by the card reading device according to the invention, the method according to the invention has the advantage of a minimum access time, since the card is pressed against the contact array at the same time as the card is fed in, and thus no additional time is required for contact-making, such as in the case of far-reaching solutions of the prior art, which envisage lowering the contact array onto the card.

One advantageous development of the card reading device according to the invention provides for the contact array to have a frame, which is provided with at least one first guide element. This frame may be in the form of a plastic injection-molded part or else in the form of a sheet-metal component. In both cases, it is expedient if a rigid and unreleasable connection exists between the frame and the contact array. In the case of the plastic injection-molded part, it is therefore expedient if the frame is cast or injection-molded directly onto the contact array. In both cases, it is expedient if the contact array is designed to be integral with the frame since, in this manner, inaccuracies in the position of the contact array owing to an additional mounting step are avoided and, in addition, the number of components is also reduced, resulting in considerable cost savings. A reliable operation is achieved if the first guide element has at least one first sliding face, which is mounted such that it can move on the second guide element in the form of a sliding bearing. These advantages come to bear, in particular, when the second guide element has at least one second sliding face, which interacts with the first sliding face of the first guide element in the manner of a slotted link in the event of a movement of the driver in the insertion direction. The design as a sliding bearing has proven to be expedient owing to the reproducibly low bearing forces in combination with an automatic feed-in.

A particularly flat design of the card reading device according to the invention is possible if the driver has at least one upper clamping part, which bears on a first flat side of the card during clamping, and a lower clamping part, which bears on a second flat side of the card during clamping, and the upper clamping part, whilst interacting with the lower clamping part, clamps the card, at least temporarily, in the event of a movement in the insertion direction. The conveying mechanism known from the prior art transports the card into the read position by means of rollers. The flat design does however require a small diameter for the rollers, which may often result in tilting. In addition, the transport rollers do not have the required degree of robustness since they continuously collide with the card, which is inserted by hand, i.e. in a largely uncontrolled manner. In order that the card can be transported at all owing to the rotation movement of the rollers, the rollers need to have a minimum degree of elastic deformation, which goes directly against a low roller diameter. Furthermore, a particularly soft roller material tends towards high amounts of wear. The card reading device according to the invention overcomes these problems by a driver clamping the card between two clamping parts and the driver, together with the card, being moved, driven by a motor, in the insertion direction and, at the same time, the driver being moved in a controlled manner along a slotted link-like guide in the distancing direction in relation to the contacts of the contact array.

One expedient measure has proven successful if the contact array is fixed to a printed circuit board and electrical contact is made with it on the printed circuit board. Fixing the contact array to the printed circuit board by means of the electrical contacts is particularly cost-effective. Similar cost advantages result if, in addition to the electrical contacts, the frame, which is fitted to the contact array in accordance with one advantageous embodiment, is also fixed to the printed circuit board. This fixing can advantageously take place by means of clip connections.

One advantageous development of the method according to the invention for transporting a card in a card reading device provides for the clamping of the card by means of the driver to be released prior to contact being made with the card by the contacts, a closure module to close the insertion opening by means of a closure, and the closure module to come into contact with the card at a narrow edge and to push it into the read position. The closure module can advantageously come into contact with the card at the narrow edge facing the closure module and push it into the read position. It is also conceivable for the closure module to grip two opposing narrow edges of the card in a pincer-like manner and for the card to subsequently be pushed into the read position. The release of the clamping prior to the end position being reached or prior to the read operation of the driver is primarily expedient because inaccuracies during manual insertion may have an effect on the position of the card in the driver, and in this manner the correct positioning of the card in relation to the contacts of the contact array can possibly not be ensured.

One exemplary embodiment of the invention will be explained in more detail below for illustrative purposes with reference to the drawings, in which:

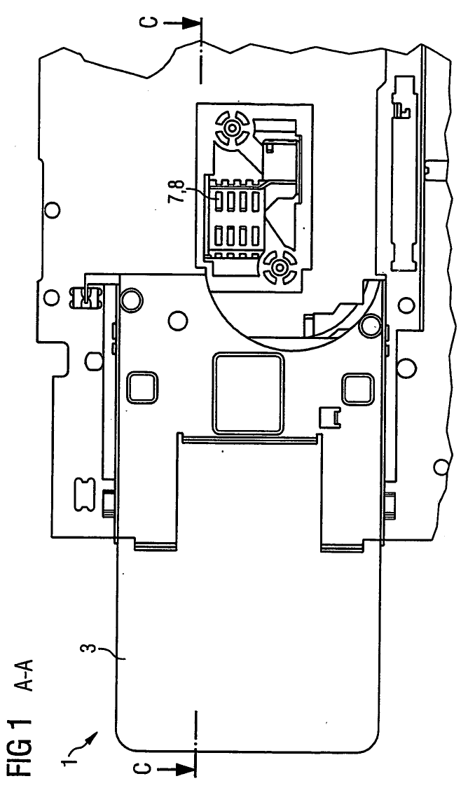

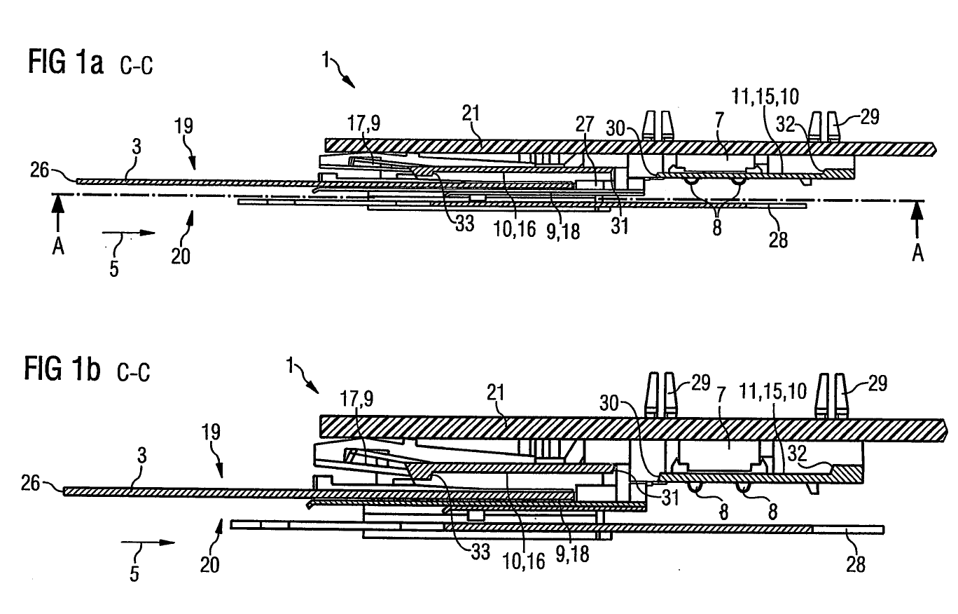

FIGS. 1 to 4 show a section in each case along section A-A in FIGS. 1a to 4a, through a card reading device according to the invention, with the components critical to the invention being illustrated and with successive movement phases of the card in the card reading device being illustrated;

FIGS. 1a to 4a show a section in each case along section CC in FIGS. 1 to 4, with components critical to the invention being illustrated and with successive movement phases of the card in the card reading device being illustrated;

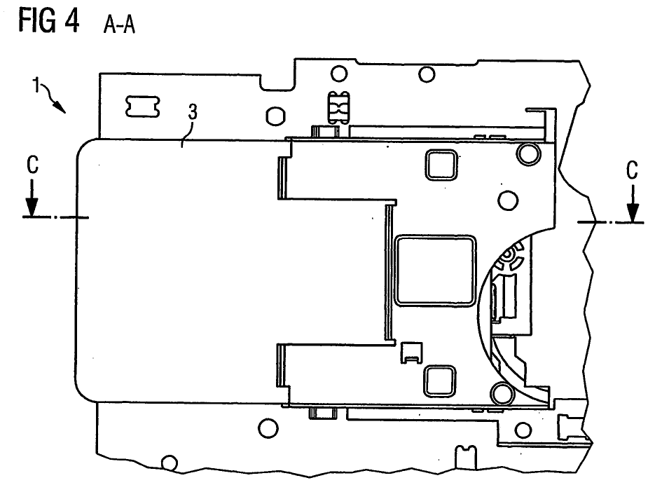

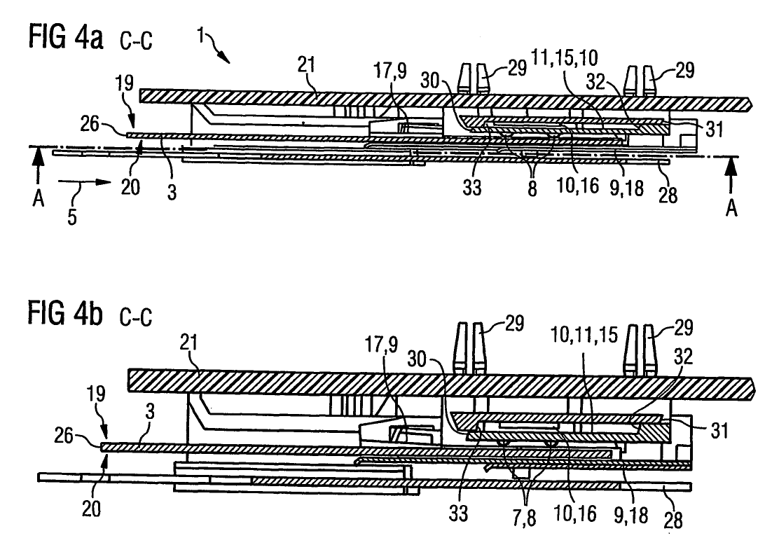

FIGS. 1b to 4b in each case show a detail from FIGS. 1a and 4a;

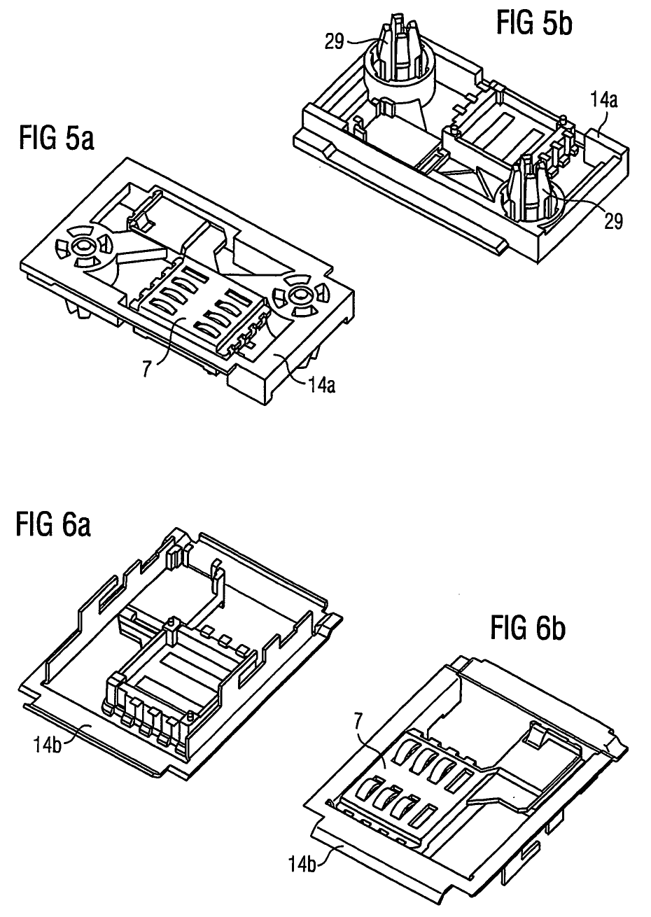

FIGS. 5a, 5b, 6a, 6b show three-dimensional views of a contact array, which is surrounded, according to the invention, by a frame which is connected to said contact array in a rigid and integral manner.

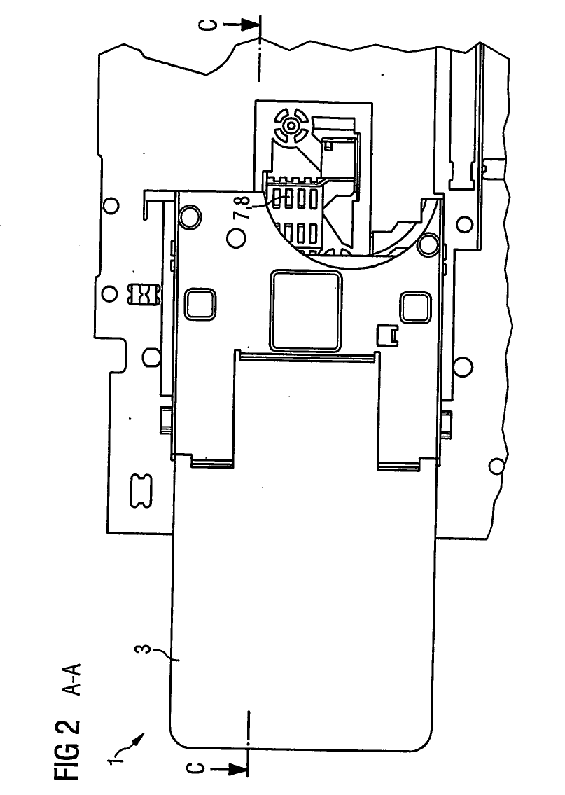

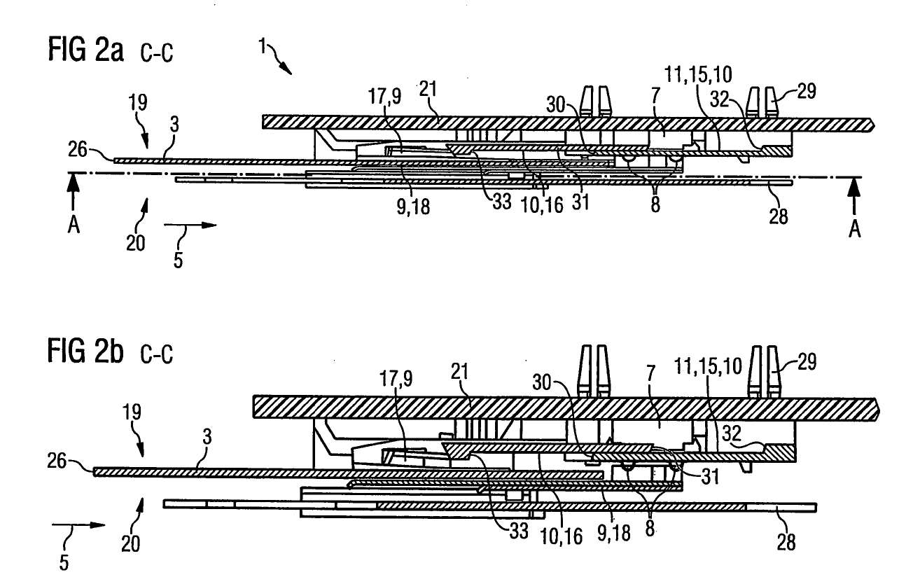

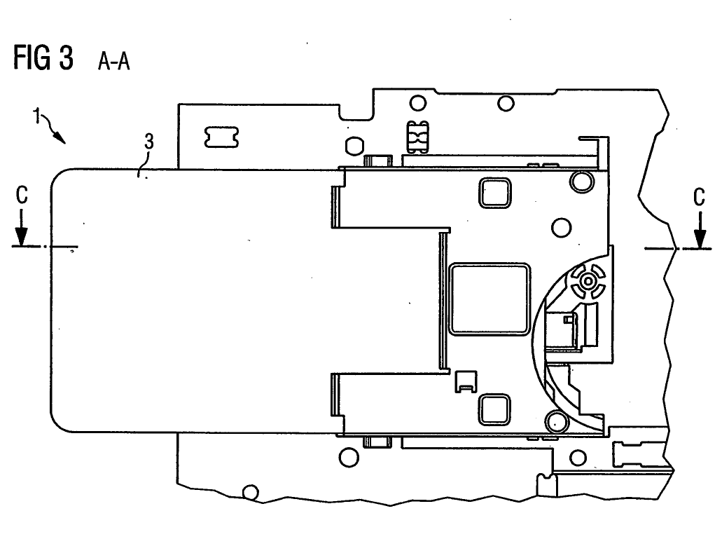

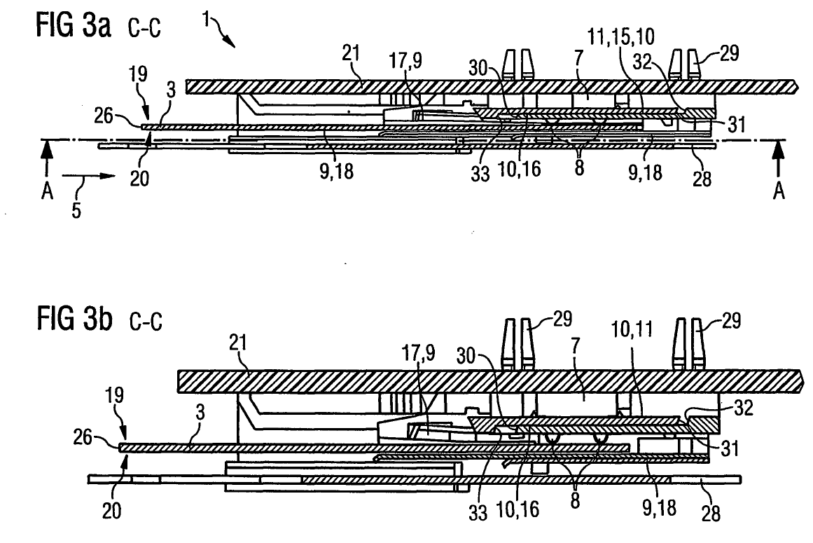

FIGS. 1 to 4 or 1a, b to 4a, b in each case illustrate a card reading device 1 having a card 3 in different phases of insertion or feeding-in of the card 3. In FIG. 1 or 1a, the card has been inserted into the card reading device 1 by means of an insert (not illustrated). In FIG. 2 or 2a, a driver 9 has gripped the inserted card 3 in a force-fitting manner by means of an upper clamping part 17 and a lower clamping part 18. In FIG. 3 or 3a, the card 3 is located in an intermediate phase between transport through the card reading device 1 on the path into the read position, which is illustrated in FIG. 4 or 4a.

Critical components of the card reading device 1 are a printed circuit board 21, the driver 9, a contact array 7 and a frame 14 surrounding the contact array as well as a base support 28 bearing all of these.

The card 3 is inserted into the card reading device 1 in the insertion direction 5 by means of an insert (not illustrated). During insertion, the card 3 slides between the upper clamping part 17 and the lower clamping part 18, which are components of the driver 9. The upper clamping part 17 is fitted to the lower clamping part 18 such that it can rotate in a first axis of rotation 27. While the upper clamping part 17 carries out a rotation movement as part of the clamping movement illustrated in FIG. 1 or FIG. 1a, the lower clamping part 18 is moved exclusively translatorily. The lower clamping part 18 is guided in the form of a slide both vertically and horizontally in a manner which is not illustrated in any more detail.

The contact array 7 is integrally connected to the injection-molded frame 14 made from plastic, and electrical contact is made with it on the printed circuit board 21. In addition, the contact array 7 is fixed to the printed circuit board 21 by means of the frame 14 on the printed circuit board 21 by means of clip connections 29 arranged on the frame 14. Eight contacts 8 are combined in the contact array 7 and protrude in a resilient manner from the contact array 7 in the distancing direction in relation to the card 3. The spring path of the individual contacts 8 is approximately 0.6 mm. The driver 9 has first guide elements 11, which interact with second guide elements 12 on the frame 14 of the contact array 7 together in the form of a guide 10. The first guide element 11 as well as the second guide element 12 are each provided with a first oblique plane 30, 31 and a second oblique plane 32, 33, which in each case overlap one another in the various phases of the card transport taking place in the distancing direction 13 in relation to the contacts 8 and interact with one another in the manner of a slotted link such that the driver 9 is moved in the distancing direction 13 in relation to the contacts 8 of the contact array 7. The first guide element 11 and the second guide element 12 each have a first sliding face 15 or a second sliding face 16 for this purpose, said sliding faces sliding past one another in the form of a sliding bearing and thus necessarily guiding the card 3 in the distancing direction 13. The first oblique planes 30, 31 ensure that the first sliding face 15 and the second sliding face 16 of the first guide element 11 and, respectively, the second guide element 12 slide on one another correctly when they initially overlap during the feeding-in of the card 3. At the same time, the driver 9, with the card 3, approaches the contacts 8 of the contact array 7 in the distancing direction 13, and contact is made with the card 3 and it is clamped on a first flat side 19 and a second flat side 20 by the upper clamping part 17 and the lower clamping part 18. The driver 9 is moved in the insertion direction 5 by a drive (not illustrated). During further feeding-in of the card 3, the sliding faces 15, 16 slide one on top of the other, as illustrated in FIGS. 2, 2a. The driver 9 or the card 3 and the contacts 8 of the contact array 7 continuously approach one another in the distancing direction 13. In the phase (illustrated in FIG. 3 or 3a) of transport of the card 3 in the card reading device 1, clamping of the card 3 is cancelled and transport elements (not illustrated) at the insert-side end of the card 3 take over the displacement of the card 3 in the direction of the contact array 7. These transport elements (not illustrated) are part of a closure module (likewise not illustrated), which closes the insert of the card reading device 1 during the reading and writing operations. In the transport phase (illustrated in FIGS. 4, 4a) of the card 3, the second oblique planes 32, 33 of the first sliding face 15 or the second sliding face 16 of the first guide element 11 or the second guide element 12 of the guide 10 slide one on top of the other such that the slotted link-like guide 10 has brought the card 3 into the final distancing position in relation to the contacts 8 of the contact array 7, and writing or reading operations can take place. In this case, the displacement is produced by means of pressure on the input-side narrow edge 26 of the card 3.

FIGS. 5a, 5b, 6a, 6b each illustrate a contact array 7 having a frame 14a or 14b surrounding the contact array 7, the frame 14a being made from plastic and being injection-molded onto the contact array, and the frame 14b being produced from sheet metal.

1. (canceled)

2. (canceled)

3. (canceled)

4. (canceled)

5. (canceled)

6. (canceled)

7. A method for transporting a card in a card reading device, the method comprising the steps of:
sliding the card in a driver when the card is inserted through an insertion opening into the card reading device;
moving the driver via a drive, in the card reading device in the insertion direction;
clamping the card with the driver, at least temporarily, in the event of a movement in the insertion direction, by means of an upper clamping part which bears on a first flat side of the card during clamping, and a lower clamping part which bears on the one second flat side of the card during clamping,
guiding the card the driver with a guide having a first guide element which is rigidly connected to the contact array whilst interacting with a second guide element on the driver which corresponds to the first guide elements, in the distancing direction in relation to the contacts of the contact array in the event of a movement in the insertion direction;
making contact with the card by contacts of the contact array;
releasing the clamping of the card by means of the driver prior to contact being made with the card by the contacts;
closing the insertion opening with a closure module closes by means of a closure; and
contacting the closure module with the card at a narrow edge facing the closure module and pushing the card into the read position.

8. (canceled)
